(19) United States
(12) Patent Application Publication
(10) Pub. No.: US 2023/0421609 A1
(43) Pub. Date: Dec. 28, 2023

(54) ORGANIZATION BASED ACCESS CONTROL WITH BOUNDARY ACCESS POLICIES

(71) Applicant: Oracle International Corporation, Redwood Shores, CA (US)

(72) Inventors: Vaibhav Shrivastava, Tracy, CA (US); Natalie Shuchyng You, Mountain View, CA (US); Somyajit Jena, San Jose, CA (US); Brajendra Bhujabal, Round Rock, TX (US); Rajan Madhavan, Foster City, CA (US)

(21) Appl. No.: 17/851,981

(22) Filed: Jun. 28, 2022

(51) Int. Cl. H04L 9/40

(52) U.S. Cl. CPC H04L 63/20; H04L 63/104

(57) ABSTRACT

An organization-based access control (OBAC) system defines resource access rights using graph-based team node trees, each comprising a plurality of hierarchically-connected team nodes. Each team node is associated with a list of members, team resources, and a team-specific access policy that defines the rights of team members to access the team resources. When a node in a tree has one or more descendant nodes, boundary access policies can be generated to define rights, of members of the node, to access resources associated with descendant nodes. Such boundary access policies may grant parent team members different access rights for child team resources than is granted to the child team members. A node management policy can grant rights to manage a portion of a team node tree. Team-specific access policies, boundary access policies, and management policies can include unique references to one or more particular resources, resource attributes, or groups of resources.

### FIELD OF THE INVENTION

The present invention relates to resource access control, and more specifically, to utilizing graph data to define resource access rights for system users.

### BACKGROUND

Policy-based access control systems grant, to users, resource access rights (such as rights to perform read and write operations) based on access policies. Two flavors of policy-based access control are role-based access control (RBAC) and attribute-based access control (ABAC).

An RBAC system defines user roles, each user role being associated with the right to perform one or more identified types of operations for one or more identified resources. Assigning a particular user role, associated with the right to perform a particular type of operation for particular resources, to a given user grants the user the right to perform the particular type of operation for the particular resources. Roles may be arranged hierarchically such that higher-level roles are associated with the rights associated with lower-level roles. Thus, in an RBAC system, management of user access rights is performed based on configuring user roles and assigning the roles to users.

For example, an RBAC system is used to manage user access rights to resources comprising help desk tickets. The RBAC system defines three user roles: Manager, HelpDesk, and Engineer. The HelpDesk role is associated with rights to view and resolve unflagged help desk tickets. The Engineer role is associated with rights to view and resolve flagged help desk tickets. The Manager role is associated with the rights of the Engineer role and the HelpDesk role, as well as with rights to create and edit all help desk tickets. A user that has been assigned any of these roles is only able to perform the granted access operation types for resources that are associated with the user's role. Thus, a user that is associated with the Engineer role is not able to create or edit tickets within the operational ticketing system, and is not able to view or resolve unflagged help desk tickets.

An ABAC system defines policies that grant rights to perform identified operation types for identified resources based on attribute rules for attributes of the requesting user, attributes of the requested resource, attributes of the environment, etc. For example, an attribute rule for a given ABAC policy grants a particular operation type for a particular set of resources if the time of the request is within an indicated time-of-day range. A resource access request is granted by an ABAC system only if an attribute rule for a policy that allows the resource access type for the target resource is satisfied for the operation request. Roles need not be created.

However, as organizations become multi-regional and multi-branded, it is important to configure resource access control for such organizations to support extensible and efficient access authorization for the various company facets. For example, an organization spanning multiple geographical locations requires access to location-specific files to be restricted to employees associated with the locations. This kind of access control can be difficult to achieve and manage using RBAC or ABAC systems, requiring complicated series of roles or attribute rules for policies, which may be difficult to understand, manage, or change as the organizational needs change.

It would be beneficial to provide an access control system that addresses the challenges indicated above.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 depicts example graph data defining a team node tree.

FIGS. 2A-2D depict example graphical user interfaces for configuring team node tree data.

FIG. 3 depicts an example team-specific access policy.

FIG. 4 depicts a flowchart for using information in a boundary access policy for an organization-based access control system to determine whether a user has the right to perform a requested operation on a target resource.

FIGS. 5A-5B depict example team-specific access policies.

FIGS. 6A-6C depict example boundary access policies.

FIG. 7 depicts a flowchart for determining denial of access rights.

FIG. 8 depicts an example organization-based access control policy resolver system.

FIGS. 9-10 depict example effective access control policies.

FIGS. 11A-11F depict example changes to hierarchical relationships within team node trees.

FIG. 12 is a block diagram that illustrates a computer system upon which an embodiment may be implemented.

FIG. 13 is a block diagram of a basic software system that may be employed for controlling the operation of a computer system.

### DETAILED DESCRIPTION

In the following description, for the purposes of explanation, numerous specific details are set forth in order to provide a thorough understanding of the techniques described herein. It will be apparent, however, that the techniques described herein may be practiced without these specific details. In other instances, well-known structures and devices are shown in block diagram form in order to avoid unnecessarily obscuring the techniques described herein.

### 1. General Overview

According to techniques described herein, an organization-based access control (OBAC) system defines resource access rights using one or more hierarchies of team nodes, referred to herein as “team node trees”, using principles of graph data. Specifically, each team node tree comprises a plurality of nodes representing OBAC teams, and a plurality of edges representing hierarchical relationships between the plurality of team nodes. A given OBAC system can comprise one or more team node trees defining the access rights of system users.

Each team node is associated with a list of team node member users, a set of team resources, and an OBAC team-specific access policy that defines the rights of team members to access the team resources. When a team node has one or more descendant nodes within the team node tree, OBAC boundary access policies can be generated to define rights, of team members, to access resources associated with descendant team nodes. Such boundary access policies may grant parent team members different access rights for child team resources than is granted to the child team members. Boundary access policies may be automatically generated based on child resource access rules defined for the team node tree, and/or may be generated based on information provided by an administrator user of the OBAC system.

A team node may also be associated with an OBAC management policy that grants rights to manage aspects of the graph data representing a portion of a team node tree. Such management policies can grant rights, to members of team nodes, to manage team-specific access policies, team membership, team resources, and/or boundary access policies for their team nodes or for descendant team nodes in the team node tree. For purposes of management policies, team nodes are resources, the access rights to which are defined using the management policies. The right to manage aspects of the graph data granted by management policies exists separately from the right of organization-wide administrators to administer the OBAC system.

OBAC policies (including team-specific access policies, boundary access policies, and management policies) are able to include unique references to particular resources, to particular resource attributes, and/or to groups of resources. Also, OBAC policies can either grant or deny identified operation types for the identified resources. Thus, using team node trees, access rights to resources of an organization may be flexibly controlled by scoping the team membership list and team resources associated with the teams. For example, teams may be used to construct geographically-based data silos, where users of each team are located within a target geography (such as a geographic “region”, e.g., the European Economic Area (EEA), Africa, North America, and South America). Each geographically-organized team can be associated with resources that are specific to the geography of the team, e.g., using geographically-based context identifiers for the resources. For example, the resources for a given geography may be stored in different tenant databases of a multi-tenant database management system.

Defining access rights using graph-based team node trees results in an access control system that is easy to administer and comprehend. Furthermore, the access rights are easy to adjust by adjusting the team node trees. Specifically, relationships between the team nodes of a team node tree can be adjusted to better suit changing organizational needs. Because effective access policies for the defined teams are determined based on the hierarchical structure of a team node tree, changing the position of a team node within a team node tree can cause the effective access policy maintained for the team node to change.

### 2. Team Node Tree

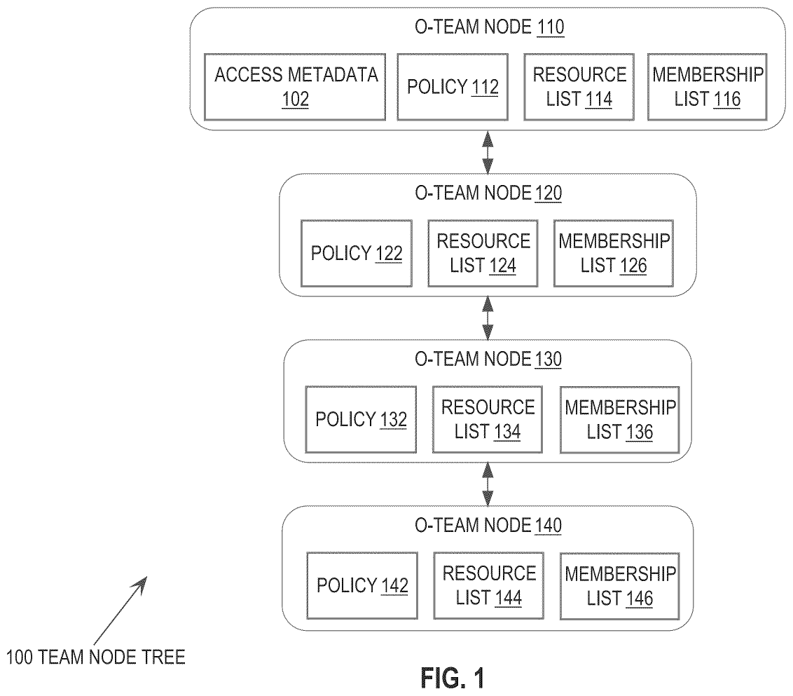

According to various implementations, an organization-based access control (OBAC) system defines the resource access rights to be granted to users based on a team node tree data structure, such as example team node tree 100 depicted in FIG. 1, maintained by a computing device. Team node tree 100 is a graph data structure that is used to model relationships between entities. A graph consists of a set of nodes (corresponding to entities) and a set of edges (corresponding to relationships).

The nodes of team node tree 100, i.e., team nodes 110-140, represent teams of the OBAC system, as described in further detail below. The team nodes are arranged hierarchically such that team nodes have parent and child relationships. Team node 110 is the root node of the hierarchy, and all other team nodes in team node tree 100 are descendants of team node 110. As used herein, a node that is above another node in the hierarchy and that is reachable from the other node is a “parent” of the other node. For example, node 110 is a parent node of nodes 120-140. Also, a node that is below another node in the hierarchy where the other node is reachable from the node is a “child” of the other node. For example, node 140 is a child node of nodes 110-130. An explicit relationship between two nodes is referred to herein as a “direct” relationship. For example, team node 130 is the direct child of team node 120, and team node 120 is the direct parent of team node 130. While not depicted in FIG. 1, team nodes can have multiple direct/indirect children and can have multiple direct/indirect parents within a team node tree.

Team node tree 100 is associated with access metadata 102, which is depicted in FIG. 1 as being associated with root team node 110. Access metadata 102 can include any type of metadata that is applicable to the nodes of the team node tree, such as default access rules for members of a team with regard to the team resources, or default boundary access policy settings such as child resource access rules, as described in further detail herein. Also, each team node of a team node tree (e.g., team node 110) is associated with:
(a) a team-specific access policy (e.g., policy 112);
(b) a membership list (e.g., membership list 116) defining which users are members of the represented team and, as such, are governed by the team-specific access policy; and
(c) a set of team resource (e.g., resource list 114) identifying one or more team resources to which the team members are granted access, as defined in the team-specific access policy.

The structure of one or more team node trees of an OBAC system, established for a given organization, may reflect organizational relationships between people within the organization. As a simple example, the organization implementing an OBAC system that includes team node tree 100 is a university that includes: a board of directors, multiple colleges managed by the board of directors, multiple fields of study within each college, and professors teaching within each field of study. In this example, team node tree 100 reflects organizational relationships between people in the example university. Thus, the members of team node 110 include all of the users within the board of directors, the members of team node 120 include all of the administrative staff/directors of a particular college (where the other colleges are represented by other direct children of team node 110, not depicted in FIG. 1), the members of team node 130 include all of the administrative staff/directors of a particular field of study within the particular college (where the other fields of study within the particular college are represented by other direct children of team node 120, not depicted in FIG. 1), and the members of team node 140 include all of the professors teaching within the particular field of study.

Alternatively, example team node tree 100 does not reflect organizational relationships between people within the organization implementing the OBAC system. In this case, the members of each of the team nodes include people from the organization with similar access requirements/rights. Relationships between team nodes may differ from organizational relationships in any way. For example, members of a team node need not be on the same organizational team as other members of the same team node, or members of a team node may represent less than all members of a particular organizational team, etc.

An OBAC system may include a plurality of team node trees (or a forest), where the nodes of one team node tree of the forest are not reachable by traversing relationships of another team node tree of the forest. In such a system, each tree can be associated with distinct access metadata such as access metadata 102.

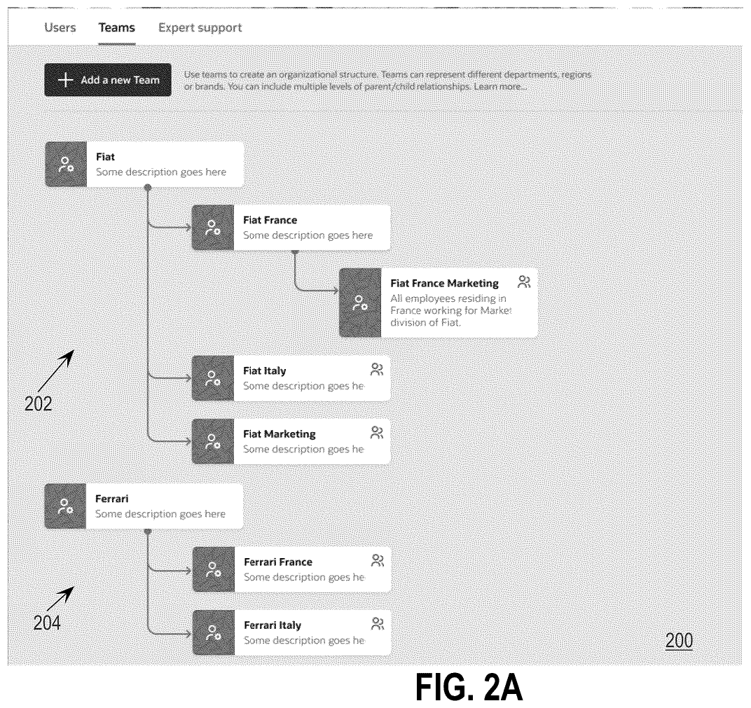

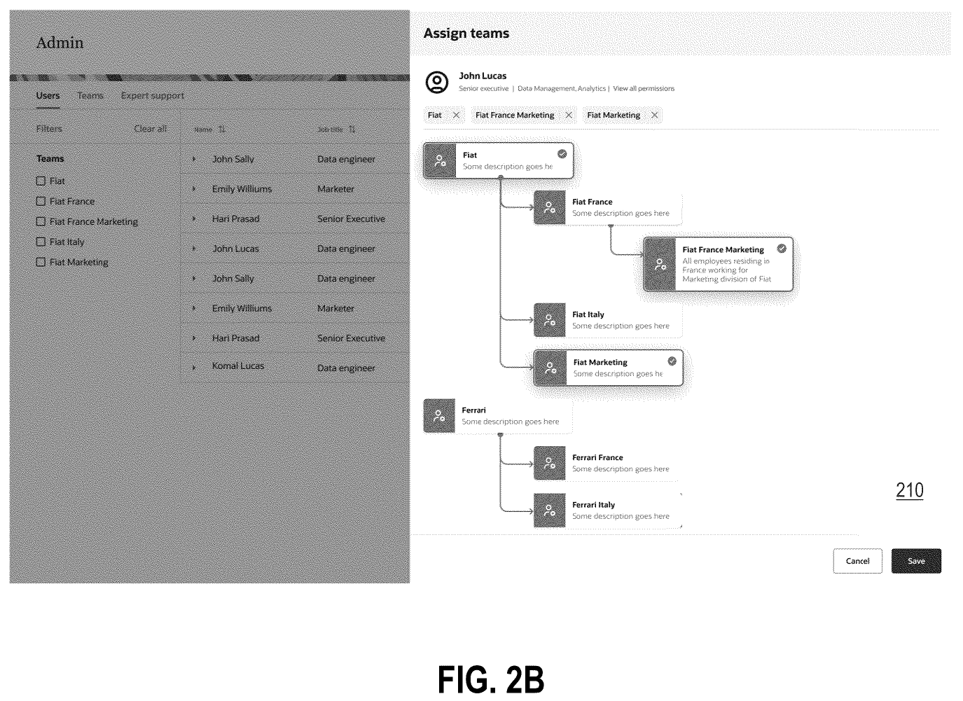

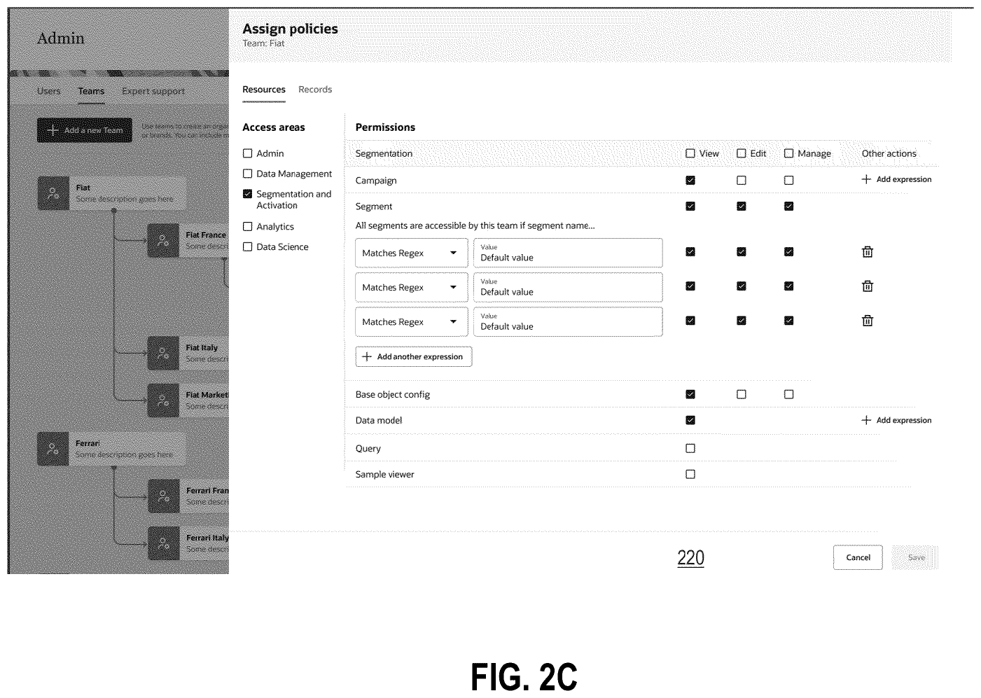

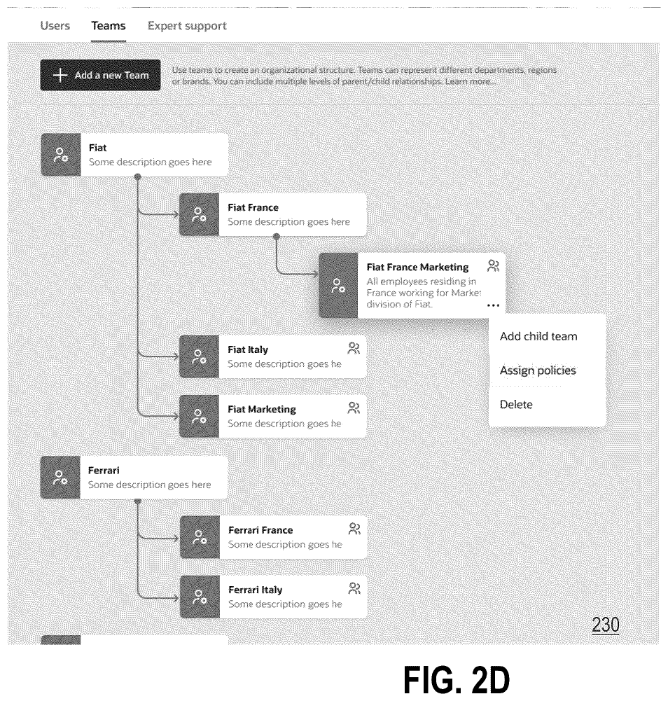

FIG. 2A depicts an example graphical user interface (GUI) 200 configured to allow an OBAC system administrator to create a team node tree. GUI 200 depicts two team node trees 202 and 204 in a forest established for the OBAC system. FIG. 2B depicts an example GUI 210 configured to allow an OBAC system administrator to add members to team nodes.

2.1. Team Resources

Each team node is associated with a team resource list that identifies a set of resources for the represented team, access to which is governed by the team-specific access policy of the team node. Each resource has a unique identifier, which can be used in OBAC policies to identify particular resources or to identify attributes of particular resources. The same resource can be referred to in the team resource lists of multiple team nodes. Furthermore, OBAC policies can identify groups of resources using a location identifier, e.g., a universal resource locator (URL), to identify a folder storing resources or references to resources. A reference to a folder in an OBAC policy identifies all resources in the folder.

Resources associated with a team can include any type of resource that can be represented by a URN and that supports access verbs, such as inspect, read, use and manage. For example, resources referred to in an OBAC policy include one or more of: files/folders maintained by a storage system on a computing device; database objects or portions of database objects maintained by a database management system; higher-level constructs such as virtual machines or resources representing workflows or projects, e.g., a campaign resource that represents an advertising campaign project that can be stopped, started, managed, edited, created, etc., and that comprises various defined attributes such as start time, stop time, run time, target audience, source data, etc. CX Unity examples of resources that can be managed include campaigns, export jobs, segments, recommendations, machine learning models, data-objects, data-attributes etc.

To illustrate in the context of team node tree 100, resource list 114 includes the following resource references (a)-(e), which uniquely identify particular resources and resource attributes within a multi-tenant database management system using universal resource names (URNs):
a) urn:tenant123:segment/segment-luxury-clothes
b) urn:tenant123:data-object/table-A
c) urn:tenant123:data-object/table-A/attribute/attr1
d) urn:tenant123:data-object/table-A/attribute/attr2
e) urn:tenant123:campaign/mail-campaign-luxury-clothes
   Resource reference (a) is a unique reference to a particular segment on disk within a particular tenant (i.e., “tenant123”) of the multi-tenant database. Resource reference (b) is a unique reference to a database object, i.e., a table named “table A” within tenant123. Resource reference (c) and (d) are unique references to attributes, of table A, named “attr1” and “attr2”. Resource reference (e) is a unique reference to a campaign resource named “campaign X” within tenant123.

According to various implementations, the list of team resources for a given team is defined by including references to the team resources in a dedicated folder (or subfolders of the dedicated folder) that is associated with the team. In such implementations, queries regarding the resources that are accessible by members of a given team may be satisfied based, at least in part, by traversing the dedicated folder for the team as well as traversing any dedicated folder for any child teams of the given team, the resources of which members of the given team are granted access via one or more boundary access policies, as described in further detail below.

2.2. Team-Specific Access Policy

Team-specific access policies, associated with team nodes, define the rights of team members to perform one or more types of operations (such as inspect, read, use, and manage) for team resources. Team-specific access policies are applicable to all users who are members of the team. The grants and denials of rights to perform access operations in a OBAC policies can identify team resources in any way, such as using unique identifiers of the resources, using identifiers of folders containing the resources, or using regular expressions that define patterns for unique identifiers or folder identifiers for the resources.

An OBAC policy can refer to any granularity of resource, such as units of memory, including blocks, extents, and segments; logical data units including files, folders, data objects, and portions of data objects; attributes of a resource such as attributes in object metadata, columns of a database object, etc.; and high-level constructs or portions of high-level constructs including virtual machines and campaigns. Data in a database can be referred to in an OBAC policy in any way, including using labels that are applied to the database data by the OBAC system.

Identifying resources at a folder level, as a group of resources, reduces the administrative work required to upkeep OBAC policies. Group resource identification allows for identifying, with a single reference, all resources for a team in the case of identifying the dedicated folder associated with the team or identifying a subset of the resources for a team in the case of identifying one or more sub-folders in the team's dedicated folder. If there are any exceptions, such as certain resources in a group of resources that require additional rights or fewer rights than are granted for the group of resources in an OBAC policy, additional access statements may be used to grant additional access rights or to deny access rights for such resources.

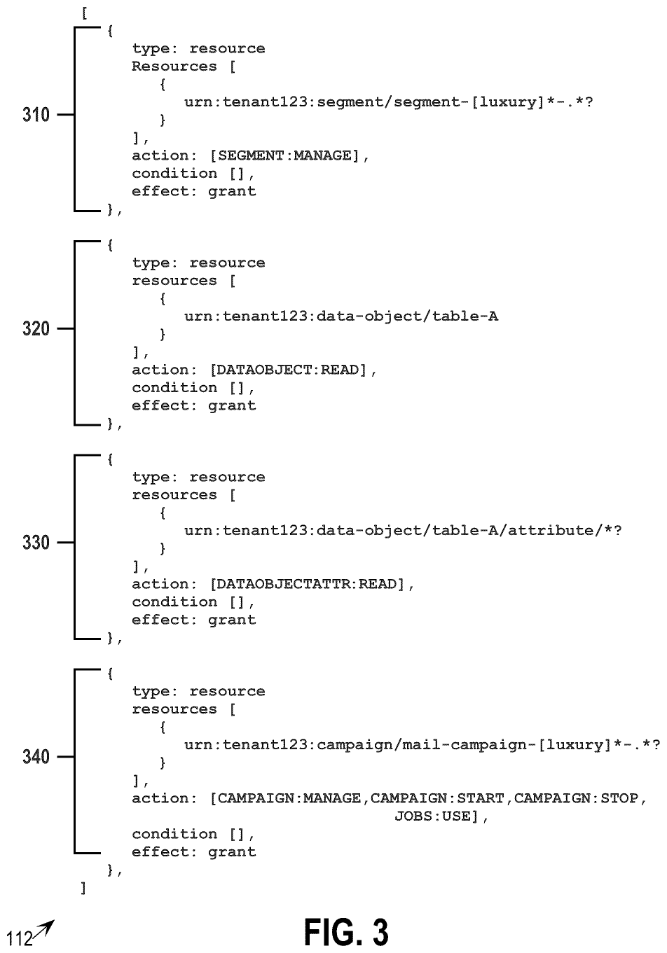

FIG. 3 depicts an example team-specific access policy 112 for team node 110, which includes four access statements (access statement 310, access statement 320, access statement 330, and access statement 340) defining rights of members in membership list 116 to perform particular types of access operations for resources in resource list 114. More specifically, access statement 310 grants the right to perform segment manage-type access operations on segments in resource list 114 that are identified by any URN that matches the regular expression: “urn:tenant123:segment/segment-[luxury]*-.*?”. Access statement 320 grants the right to perform data object read-type access operations on the data object in resource list 114 that is identified by “urn:tenant123:data-object/table-A”. Access statement 330 grants the right to perform data object attribute read-type access operations on attributes of data objects in resource list 114 that are identified by any URN that matches the regular expression: “urn:tenant123:data-object/table-A/attribute/*?”. Access statement 340 grants the rights to perform campaign manage-, start-, and stop-type access operations and jobs use-type access operations on campaigns in resource list 114 that are identified by any urn that matches the regular expression: “urn:tenant123:campaign/mail-campaign-[luxury]*-.*?”.

When a member of a given team requests performance of a particular type of access operation on a team resource, the right of that team member to perform the operation is based on the team-specific access policy. To illustrate given example access policy 112 of FIG. 3, a member of team node 110 would be granted the right to read attr1 of table A within tenant123, but would be denied any other kind of access operation on that attribute.

FIG. 2C depicts an example GUI 220 that is configured to allow an OBAC system administrator to create a team-specific policies. Techniques similar to those depicted in FIG. 2C may be used to create or edit any kind of OBAC policy. FIG. 2D further depicts a GUI 230 that is configured to allow an OBAC system administrator to assign policies or access statements to be the team-specific policy (or part of the team-specific policy), a boundary policy (as described in further detail below), or a management policy (also described in further detail below) for a team node.

According to various implementations, an OBAC system application automatically generates a default team-specific access policy for team nodes in a team node tree based on default access rules in access metadata for the team node tree. In such implementations, an administrator of the OBAC system can edit the default access statements to customize the statements for individual team nodes. To illustrate, access metadata 102 includes a default access rule that indicates that team members have a default right to inspect, read, and use team resources.

Default access rules can identify resources or resource locations, as indicated above, using URNs, URLs, and/or regular expressions. Default access rules can also identify resources based on any kind of resource attribute, such as location, type, resource identifier, name, etc. Furthermore, default access rules can identify teams to which the default access rules are applicable in any way, including identifying particular team nodes and/or identifying attributes of teams (such as name, type, number of users in the team list, position within the team node tree, etc.) to which the various default access rules apply. For example, access metadata 102 includes a default access rule that indicates that members of teams that are at least two hops away from the root node of the team node tree are denied the right to manage virtual machine-type resources associated with the team node.

Furthermore, the presence of a resource or a resource reference in a dedicated folder for a team node can imply a certain level of access that is granted to the team members without requiring explicitly granting the right to perform the implicit access operations in the team-specific access policy. For example, access metadata 102 indicates that all team members are implicitly granted the right to perform inspect-type operations on team resources. As another example, access metadata 102 indicates that all team members are implicitly granted the right to perform use-type operations on team resources that are virtual machines. These implicit rights are included in effective team policies, described in detail below, notwithstanding the absence of the rights in team-specific policies for the teams. Nevertheless, an explicit denial of implicit rights for a given team results in denying the implicit rights to team members.

### 3. Boundary Access Policies

Based, at least in part, on the graph data defining a team node tree in which a particular team node resides, the members of the particular team node are granted rights to perform access operations on resources associated with child team nodes that are descendants of the particular team node. Specifically, when a team node has one or more descendants, OBAC boundary access policies can be established to define rights, of members of the team node, to access resources associated with descendant team nodes. Boundary access policies function in a manner similar to team-specific OBAC policies described above.

Furthermore, in a manner similar to generating default team-specific access policies described above, boundary access policies for a team node can be automatically generated based on child resource access rules in access metadata 102. Child resource access rules can be configured similarly to default access rules, as described above. As an illustration, access metadata 102 includes child resource access rules that indicate that members of each team node in the team node tree has the default right to perform inspect-type operations for the resources associated with all child nodes that are reachable from the team node in the team node tree. Example access metadata 102 further includes child resource access rules that indicate that members of each team node in the team node tree has the default right to perform read-type operations for resources associated with child nodes that are at most one hop away from the team node in the team node tree. According to various implementations, default boundary access policies are generated for each team node having descendants in the team node tree. Default boundary access policies can be augmented or replaced by administrator-generated boundary access policies. In this way, administrators are able to adjust the rights of teams with regard to child team resources as fits the needs of the organization.

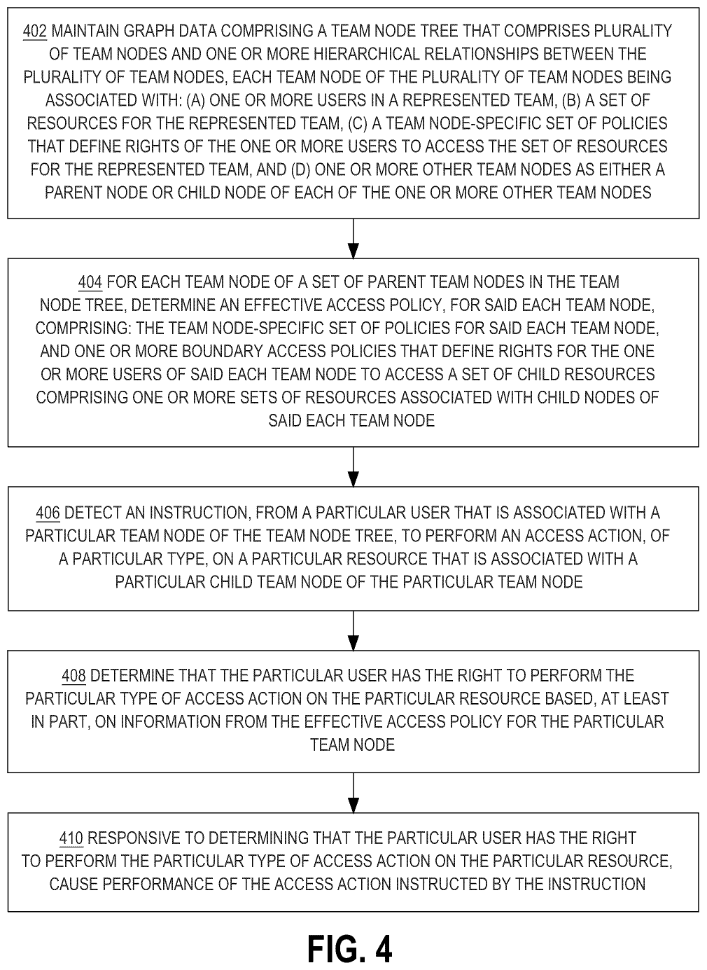

FIG. 4 depicts a flowchart 400 for using information in a boundary access policy for an OBAC system to determine whether a user has the right to perform a requested operation on a target resource. Specifically, at step 402, graph data is maintained, the graph data comprising a team node tree that comprises a plurality of team nodes and one or more hierarchical relationships between the plurality of team nodes, each team node of the plurality of team nodes being associated with: (a) one or more users in a represented team, (b) a set of resources for the represented team, (c) a team node-specific set of policies that define rights of the one or more users to access the set of resources for the represented team, and (d) one or more other team nodes as either a parent node or child node of each of the one or more other team nodes. For example, team node tree 100 depicted in FIG. 1 is maintained in storage by a computing device. In this example, resource list 124 for node 120 includes the following resource references (a)-(c), which uniquely identify respective segments on disk for tenant123 of the multi-tenant database:
a) urn:tenant123:segment/segment-A1
b) urn:tenant123:segment/segment-A2
c) urn:tenant123:segment/segment-A3

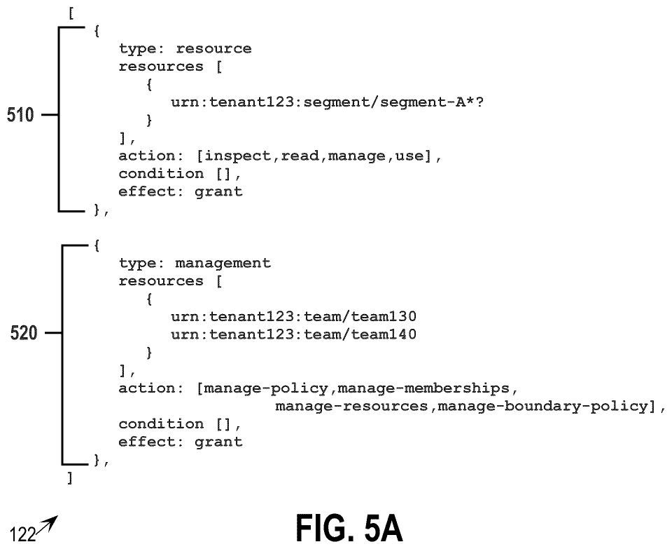

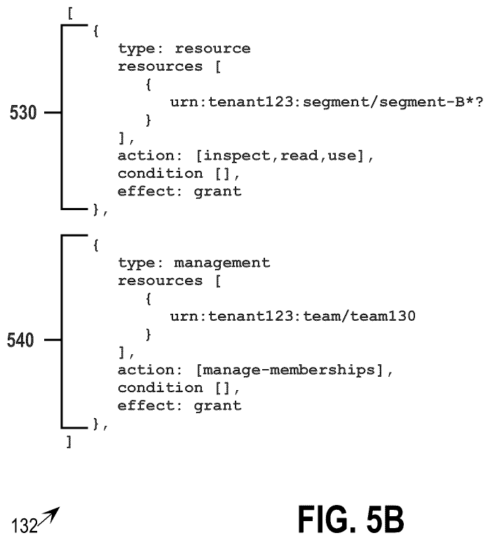

FIG. 5A depicts an example team-specific access policy 122 for node 120, which includes an access statement 510 granting the right for members in membership list 126 to access database resources in resource list 124 indicated above. Access statement 510 grants the right to perform inspect-, read-, manage-, and use-type access operations on segments in resource list 124 that are identified with any URN that matches the regular expression: “urn:tenant123:segment/segment-A*?”. In the example of FIG. 5A, access statement 510 includes the default access rights (inspect, read, and use) identified by the example default access rules in access metadata 102 identified above, and has been adjusted to include the right to perform manage-type operations, which is not indicated by the default access rules. Team-specific access policy 122 further includes a management statement 520, such as an identity and access management (IAM) policy, as described in further detail below.

Furthermore, in this example, resource list 134 for node 130 includes the following resource references (a)-(c), which uniquely identify respective segments on disk for tenant123 of the multi-tenant database:
a) urn:tenant123: segment/segment-B1
b) urn:tenant123:segment/segment-B2
c) urn:tenant123:segment/segment-B3

FIG. 5B depicts an example team-specific access policy 132 for node 130, which includes an access statement 530 granting the right for members in membership list 136 to access database resources in resource list 134 indicated above. Access statement 530 grants the right to perform inspect-, read-, and use-type access operations on segments in resource list 134 that are identified by any URN that matches the regular expression: “urn:tenant123:segment/segment-B*?”. Team-specific access policy 132 further includes a management statement 540, as described in further detail below.

Also in this example, resource list 144 for node 140 includes the following resource references (a)-(c), which uniquely identify respective segments on disk for tenant123 of the multi-tenant database:
a) urn:tenant123:segment/segment-C1
b) urn:tenant123:segment/segment-C2
c) urn:tenant123:segment/segment-C3

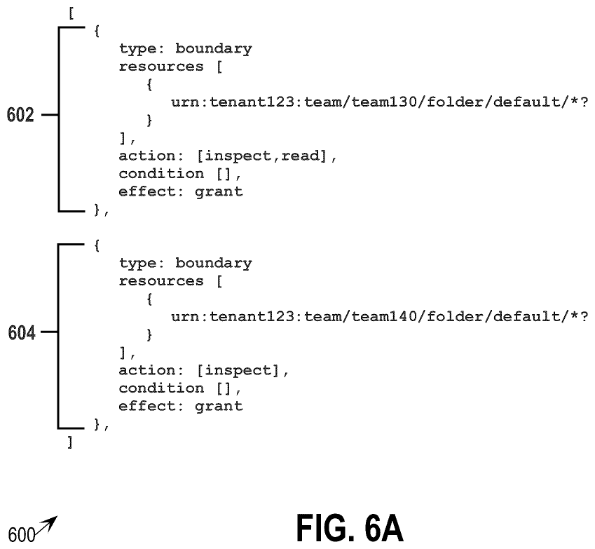

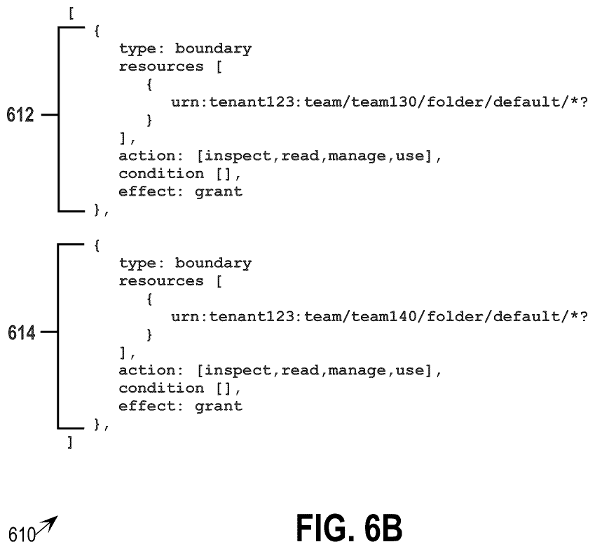

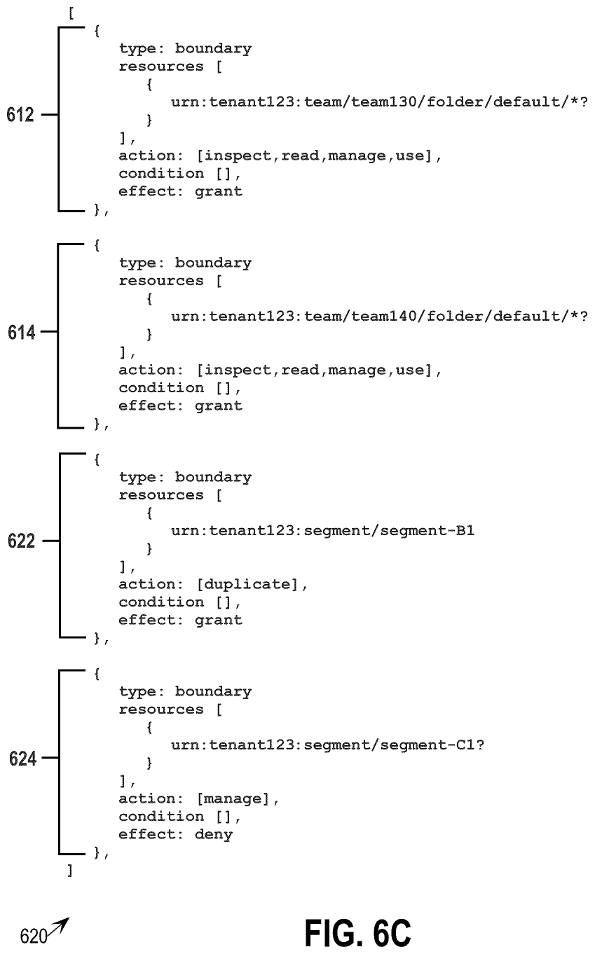

Based on the child resource access rules in access metadata 102, a computing device automatically generates, for node 120, a default boundary access policy 600, depicted in FIG. 6A. Boundary access policy 600 defines the access rights of members of team node 120, in membership list 126, (a) to access resources for child team node 130 in resource list 134 and (b) to access resources for child team node 140 in resource list 144. Default boundary access policy 600 includes an access statement 602 that grants the default access rights for members of team node 120 to access resources in resource list 134. Specifically, because team node 130 is at most one hop away from team node 120 within team node tree 100, access statement 602 grants both the right to perform inspect-type access operations and read-type access operations for the resources in resource list 134, which is indicated by using a regular expression that identifies all of the contents of the dedicated folder associated with team node 130 as follows: “urn:tenant123:team/team130/folder/default/*?”.

Also, default boundary access policy 600 includes an access statement 604 that grants the default access rights for members of team node 120 to access resources in resource list 144. Specifically, because team node 140 is more than one hop away from team node 120 within team node tree 100, access statement 604 grants only the right to perform inspect-type access operations on the resources in resource list 144, which is indicated using a regular expression that identifies all of the contents of the dedicated folder associated with team node 140 as follows: “urn:tenant123:team/team140/folder/default/*?”.

A boundary access policy governing the rights of members of a particular team node to access resources of a child team node may omit a right that is granted by the child node's team-specific access policy. For example, the team-specific access policy of a particular team node grants the right to perform manage-type operations for a particular resource associated with the particular team, and a boundary access policy for a parent team node that governs the rights of members of the parent team node to access resources of the particular team node does not grant (or denies) the right to perform manage-type operations for the particular resource.

Furthermore, the rights granted by a boundary access policy for a given parent team node are not limited to the rights granted by the team-specific access policy for the child node. Specifically, members of a parent team node can be granted rights to perform a greater variety of access operations than members of a child team with respect to the resources of the child team. To illustrate, an administrator user adjusts default access statements 602 and 604 in boundary access policy 600 for node 120, as shown by the updated types of operations granted by access statements 612 and 614 in boundary access policy 610 of FIG. 6B. In access statement 612 of adjusted boundary access policy 610, users of team node 120 are granted the right to perform inspect-, read-, manage-, and use-type access operations on resources in resource list 134. Given example team-specific access policy 132 in FIG. 5B, users of team node 120 are granted the right to manage resources for team node 130, while users of team node 130 are not granted the right of managing the resources for team node 130.

Furthermore, example boundary access policy 620, depicted in FIG. 6C, governs rights of members of team node 120 to access resources for descendant nodes of node 120. Boundary access policy 620 depicts identifying resources at a folder level in some access statements, and then refining the group-based rights using additional access statements. Specifically, boundary access policy 620 refines group-based access statements 612 and 614 using more specific access statements 622 and 624. While access statement 612 grants the right to perform operations to inspect, read, manage, and use all resources associated with team node 130 to the members of team node 120, access statement 622 grants the additional right to perform duplicate-type access operations on the segment in resource list 134 identified by “urn:tenant123:segment/segment-B1”. Thus, in addition to the rights to perform inspect-, read-, manage-, and use-type access operations on all of the resources in list 134 (including the resource “segment-B1”), users of team node 120 are further able to perform duplicate-type operations on “segment-B 1”.

Also, while access statement 614 grants the right to perform operations to inspect, read, manage, and use all resources associated with team node 140 to the members of team node 120, access statement 624 denies the right to perform manage-type access operations on the segment in resource list 144 identified by “urn:tenant123:segment/segment-C1”, as described in further detail below. Notwithstanding any other grant of an access right, explicit denial of an access right in an OBAC policy results in denial of the access right for users to whom the policy applies. For example, though the right to manage all resources in resource list 144 is granted to members of team node 120 in access statement 614, the effect of access statement 624 is to deny the right to manage the resource “segment-C1”, while preserving the right for members of team node 120 to manage the other resources in resource list 144.

### 4. Deny

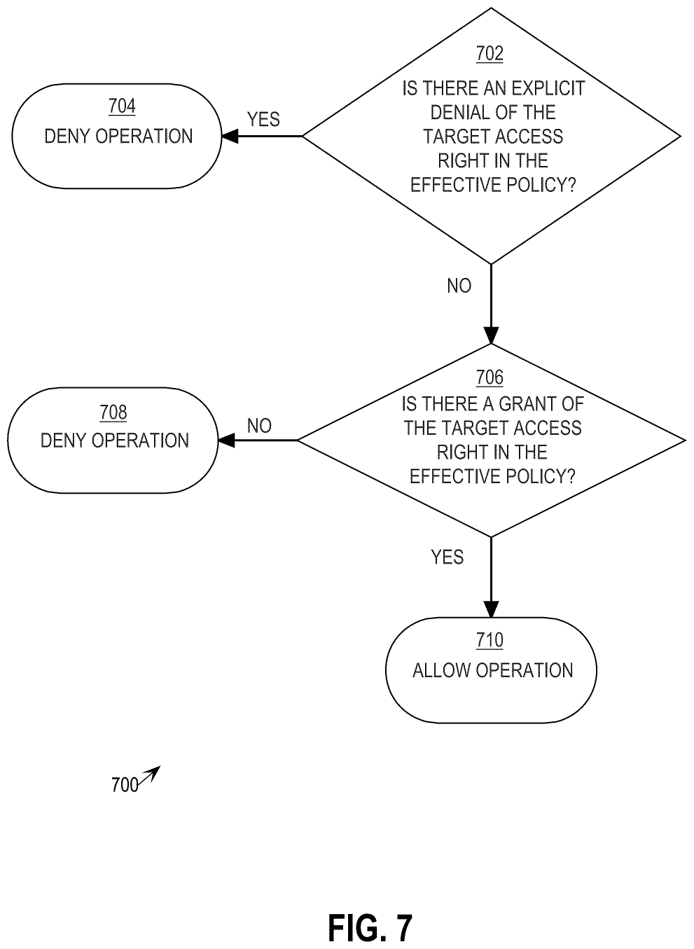

Access statements in an OBAC policy can either grant or deny rights to perform particular types of access operations for particular resources. As depicted in flowchart 700 of FIG. 7, a deny-type access statement takes precedence over any contrary allow-type access statements. Specifically, when determining whether to allow a particular requested access operation, at step 702, it is determined whether there is an explicit denial of the target access right, i.e., a right that is required by the particular requested access operation, in an applicable OBAC policy. If there is an explicit denial of the target access right in the applicable OBAC policy, then control passes to step 704 and the final decision is to deny the requested operation. If there is not an explicit denial of the target access right in the applicable OBAC policy, then control passes to step 706, and it is determined whether there is a grant of the target access right in the applicable OBAC policy. If there is not a grant of the target access right in the applicable OBAC policy, then control passes to step 708 and the final decision is to deny the requested operation. Otherwise, control passes to step 710 and the final decision is to allow the requested operation.

Thus, a denial of access right takes precedent over any grant of the access right in the OBAC system. The precedence of denial, as well as the ability to refer to resources as a group of resources (e.g., as described above in connection with identifying a folder that contains resource references for a team node) allows for greater flexibility in defining access rights in OBAC policies.

### 5. Access Policy Resolver

Returning to the discussion of flowchart 400 of FIG. 4, at step 404, for each team node of a set of parent team nodes in the team node tree, determining an effective access policy, for said each team node, comprising: the team node-specific set of policies for said each team node, and one or more boundary access policies that define rights for the one or more users of said each team node to access a set of child resources comprising one or more sets of resources associated with child nodes of said each team node. For example, a computing device automatically generates an effective access policy for each team node based on the team-specific access policy for the team node and any applicable boundary access policies for the team node.

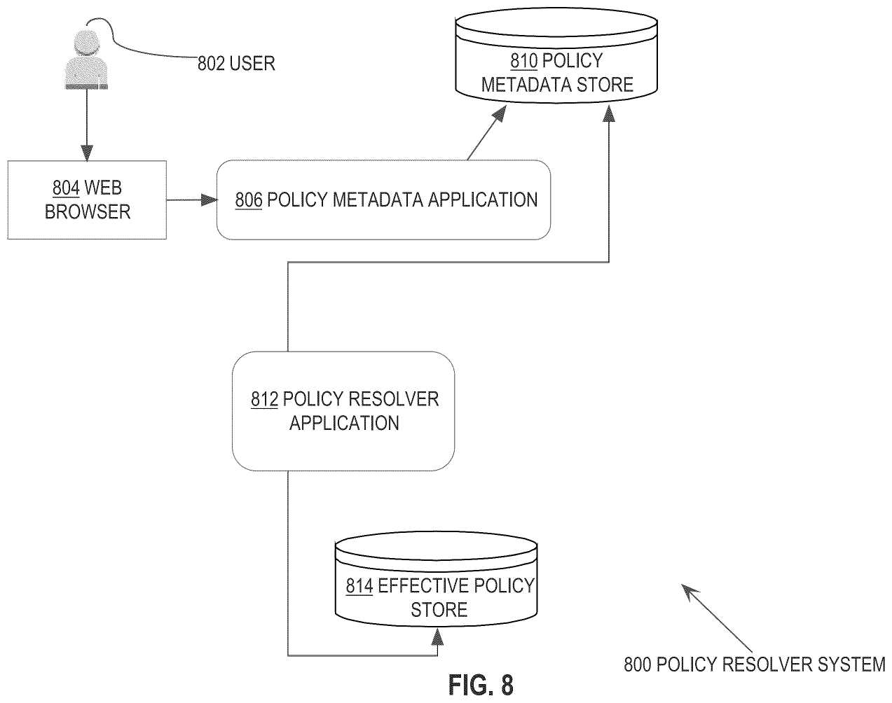

FIG. 8 depicts an example OBAC policy resolver system 800, which is implemented by one or more computing devices that are communicatively coupled to storage, such as storage that stores policy metadata store 810 and effective policy store 814. As depicted in FIG. 8, a user 802, such as an OBAC system administrator, provides OBAC policy information to an policy metadata application 806 via a web browser 804. A web browser 804 is an application, running on a computing device, that is configured to interpret and display web pages, e.g., retrieved from a network. FIGS. 2A-2D depict example GUIs that can be used by user 802 to input OBAC policy information. The OBAC policy information provided via web browser 804 can include access control metadata, team node tree information, and policy definition information. The received team node tree information may be information defining a team node tree, or a portion of a team node tree, for the target organization, or may be information adjusting an established team node tree or a portion of an established team node tree.

In system 800, policy metadata application 806 stores the received OBAC policy information in a policy metadata store 810. A policy resolver application 812 automatically retrieves the OBAC policy information from policy metadata store 810. For example, a change event is published when any change is made to policy metadata store 810, and policy resolver application 812 retrieves OBAC policy information from store 810 upon detecting a change event. Using the information in policy metadata store 810, policy resolver application 812 computes effective OBAC policies. Policy resolver application 812 writes the effective OBAC policies to an effective policy store 814, from which the effective OBAC policies can be used, e.g., by an access policy engine application such as Speedle, Open Policy Agent, etc., for OBAC policy enforcement to enact resource access control.

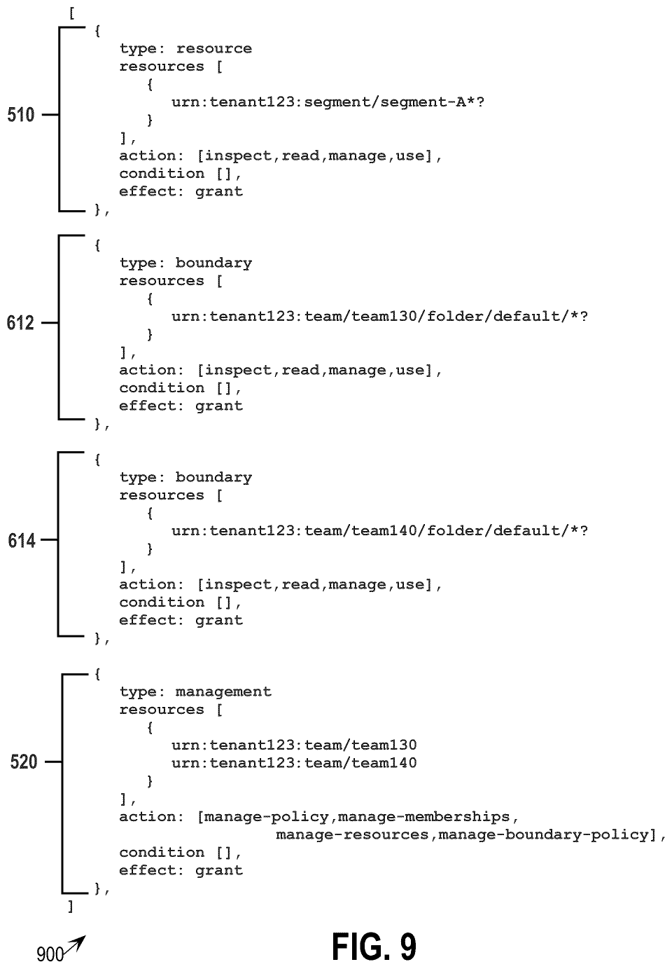

FIG. 9 depicts an example effective access policy 900 for a member of team node 120, who is not a member of any other team. Based on the example team-specific access policy 122 of FIG. 5A and the example boundary access policy 610 for team node 120 depicted in FIG. 6B, effective access policy 900 includes the team-specific access statement 510 and management statement 520, as well as the boundary access statements 612 and 614.

If a member of a particular team is also a member of one or more other teams, the effective access policy for that user is generated from the effective access policies of all of the teams of which the user is a member.

### 6. Resource Access Control

At step 406 of flowchart 400, an instruction is detected, from a particular user that is associated with a particular team node of the team node tree, to perform an access operation, of a particular type, on a particular resource that is associated with a particular child team node of the particular team node. For example, an access policy engine application implemented on a computing device detects an instruction, from a member of team node 120 (who is not associated with any other team node), to perform a manage-type access operation on urn:tenant123:segment/segment-B1. Steps 408 and 410 are performed responsive to detecting the instruction.

At step 408 of flowchart 400, it is determined that the particular user has the right to perform the particular type of access operation on the particular resource based, at least in part, on information from the effective access policy for the particular team node. For example, the access policy engine application accesses effective policy store 814, which stores effective access policy 900 generated for members of team node 120. Effective access policy 900 includes boundary access statement 612 that grants the right, to members of team node 120, to manage resources in the folder at URL “tenant123:team/team130/folder/default/”, which is the dedicated folder for team node 130 that stores resources or references to resources in resource list 134 for the team node. The access policy engine application determines, based on boundary access statement 612, that the requesting user has the right to perform manage-type operations on urn:tenant123:segment/segment-B1, which is in resource list 134.

At step 410, responsive to determining that the particular user has the right to perform the particular type of access operation on the particular resource, performance of the access operation instructed by the instruction is caused. For example, in response to determining that the user has the right to perform the manage-type operation on urn:tenant123:segment/segment-B1, the requested manage-type operation is performed on urn:tenant123:segment/segment-B1.

As indicated above, a boundary access policy may grant, to users of a parent team, different rights (such as broader rights) to access resources associated with a child team than are granted to the members of the child team by the team-specific access policy of the child team.

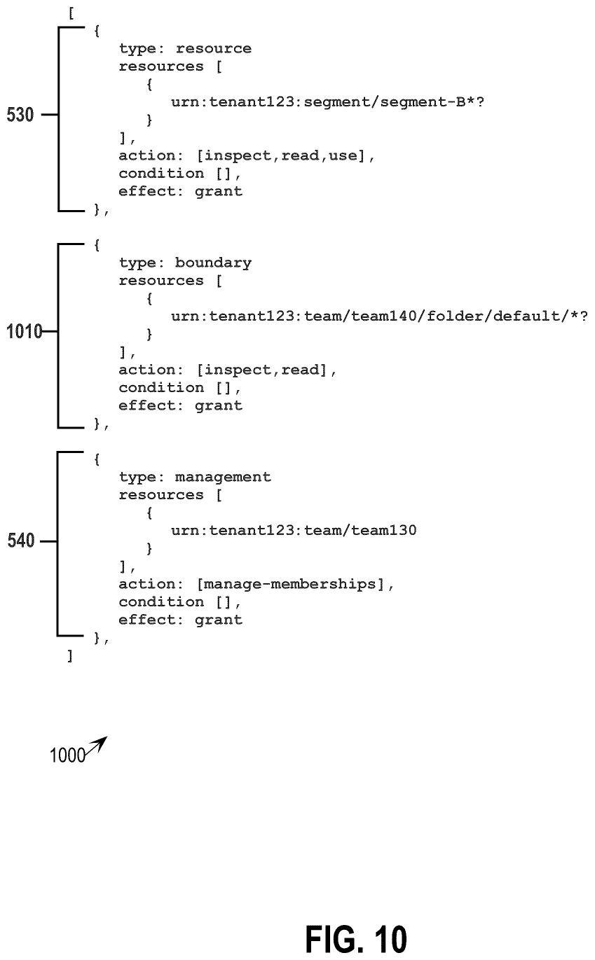

Continuing with the previous example presented in connection with flowchart 400, an effective access policy 1000, depicted in FIG. 10, is generated for team node 130 and stored in effective policy store 814. Effective access policy 1000 includes access statement 530 and management statement 540 from team-specific access policy 132 associated with team node 130. Effective access policy 1000 further includes a boundary access statement 1010 that defines access rights for members of team node 130 regarding the resources associated with child team node 140. The rights grated in boundary access statement 1010 are based on the example child resource access rules in access metadata 102 described above.

In this example, the access policy engine application detects a second instruction, from a user of team node 130 (who is not associated with any other team node), to perform a manage-type access operation for urn:tenant123:segment/segment-B1. Based on effective access policy 1000, the access policy engine application determines that, unlike the member of team node 120 described above, the second user does not have the right to perform manage-type operations on urn:tenant123:segment/segment-B1. Specifically, with reference to the denial flowchart 700 of FIG. 7, there is no explicit denial of the target access right (i.e., manage-type operations) for the target resource in effective access policy 1000 (step 702). Thus, control passes to step 706, at which point it is determined that there is not a grant of the target access right in effective access policy 1000. Thus, control passes to step 708, and the operation is denied.

### 7. Team-Level Membership Management

According to various implementations, OBAC policies grant rights to manage aspects of the graph data representing a portion of a team node tree. Such “management”-type policies can grant rights, to members of team nodes, to manage team-specific access policies, team membership, team resources, and/or boundary access policies for their team nodes or for descendant team nodes in the team node tree. The right to manage aspects of the graph data granted by management policies exists separately from the right of organization-wide administrators to administer the OBAC system, such as is described as being performed by user 802 of FIG. 8.

When a particular team is granted the right to adjust the team-specific access policies or the boundary policies of descendent teams, the members of the particular team are able to grant, at most, the rights that are granted to members of the particular team. Also, the members of the particular team, which is granted the right to adjust the team-specific access policies or the boundary policies of descendent teams, are able to explicitly deny rights for descendent child teams.

To illustrate a management policy, effective access policy 900 (FIG. 9) generated for team node 120 includes management statement 520 that grants members of team node 120 the rights to managing team-specific access policies, team membership, team resources, and boundary access policies of team nodes 130 and 140, as indicated by the following URNs that uniquely identify team nodes 130 and 140, respectively: “urn:tenant123:team/team130” and “urn:tenant123:team/team140”. Effective access policy 1000 (FIG. 10) generated for team node 130 also includes a management statement 540 that grants members of team node 130 the right to manage only membership of team node 130, as indicated by the URN: “urn:tenant123:team/team130”. This self-management may be useful when membership of the team changes rapidly.

Management access policies can be used by an OBAC system to push hierarchical data management to users associated with team nodes at any level within a team node tree. Because administrators of the OBAC system are able to grant rights to manage portions of team node tree data to members of team nodes, members of the nodes are able to make changes needed to keep the OBAC system up-to-date with a changing organization. For example, in a large company, many people join and leave the company on a weekly basis. Distribution of the right to manage team membership to members of team nodes allows membership changes to be made at a local level by the people who understand what changes are needed.

To illustrate, the access policy engine application detects an instruction, from a user of team node 120 (who is not associated with any other team node), to perform a manage-type access operation for graph data defining membership list 126 for team node 120. The access policy engine application determines, based on effective access policy 900, that the user does not have the right to perform manage-type operations on membership list 126 for team node 120. Specifically, with reference to flowchart 700 of FIG. 7, there is no explicit denial of the target access right (i.e., manage-memberships for team node 120) in effective access policy 900 (step 702). Thus, control passes to step 706, at which point it is determined that there is not a grant of the target access right in effective access policy 900. Thus, control passes to step 708, and the operation is denied.

As a further example, the access policy engine application detects an instruction, from the user of team node 120, to perform a manage-type access operation for graph data defining membership list 136 for team node 130. The access policy engine application determines, based on effective access policy 900 (specifically, based on management statement 520), that the user has the right to perform manage-type operations on membership list 136 for team node 130. In response to determining that the user has the right to perform the manage-type access operation for graph data defining the membership list 136 for team node 130, the manage-type operation is performed on membership list 136 for team node 130.

### 8. Effect of Team Node Position within the Hierarchy

The needs of an organization implementing the OBAC system may change over time. Accordingly, relationships between the team nodes of an OBAC team node tree can be adjusted to better suit the changing organizational needs. Because effective access policies are determined based on the hierarchical structure of a team node tree, changing the position of a team node within a team node tree causes the effective access policy maintained for the team node to change. Specifically, because boundary access policies grant members of parent team nodes access to child team node resources, changing relationships between team nodes changes the access rights granted for child node resources. Example changes to hierarchical relationships within a team node tree that can result in changed effective access policies for team nodes of the tree include: adding a node to a team node tree, removing a node from a team node tree, moving all or a portion of one team node tree to be part of another team node tree, dividing a team node tree into multiple team node trees, and changing the positions of nodes of a team node tree such that one or more nodes in the tree have adjusted parent-child relationships.

According to various implementations, when a change to hierarchical relationships within a team node tree is detected, any resulting changes, to effective access policies maintained for team nodes of the team node tree, are automatically determined based on access metadata maintained for the team node tree. According to various implementations, an OBAC administrator user is notified regarding any automatic changes made to effective access policies, or regarding any statements in effective access policies that need to be adjusted because of a change to hierarchical relationships within a team node tree, to give the user an opportunity to adjust the effective access policies. According to various implementations, management statements that are affected by a hierarchical relationship change are invalidated, or flagged for update, to facilitate management statement updates by administrator users.

Examples of changes to hierarchical relationships within a team node tree are described below in the context of an implementation in which changes to effective access policies are automatically made, based on applicable access metadata, in response to detecting changes to hierarchical relationships within a team node tree.

8.1. Adding a Node to a Team Node Tree

One change to hierarchical relationships within a team node tree that can result in changed effective access policies is adding a team node to a team node tree. According to various implementations, adding a new team node to a tree requires adjusting the effective access policies for all parent nodes, reachable from the new team node, to include a boundary access statement defining parent access rights for the resources of the new team node. The new team node is generally configured with the required OBAC policies and resource list as part of the creation process.

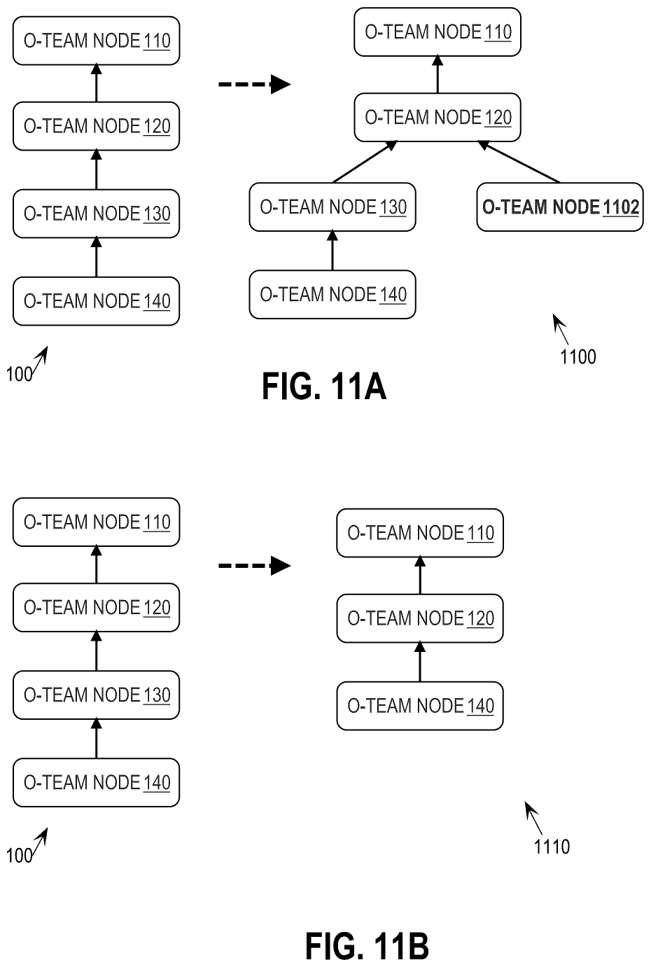

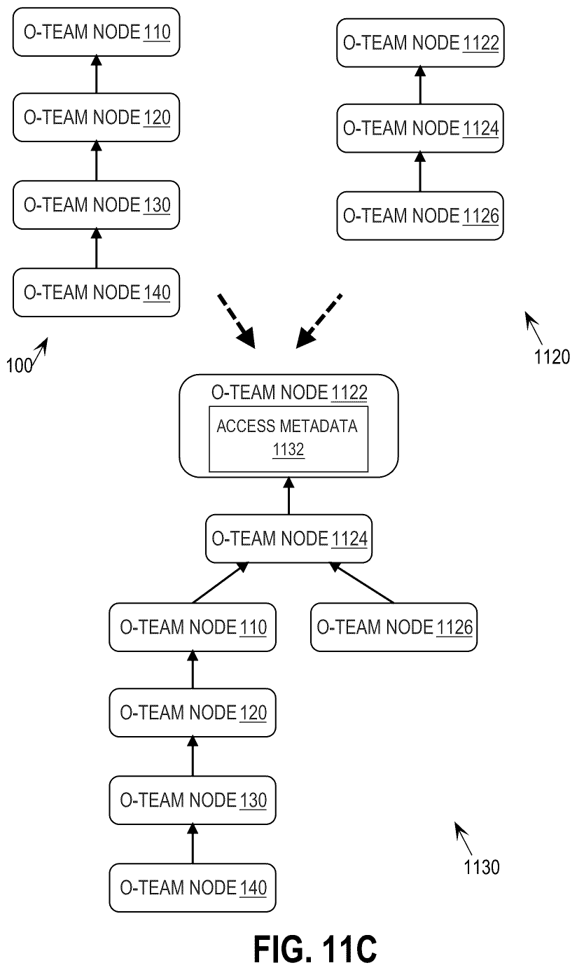

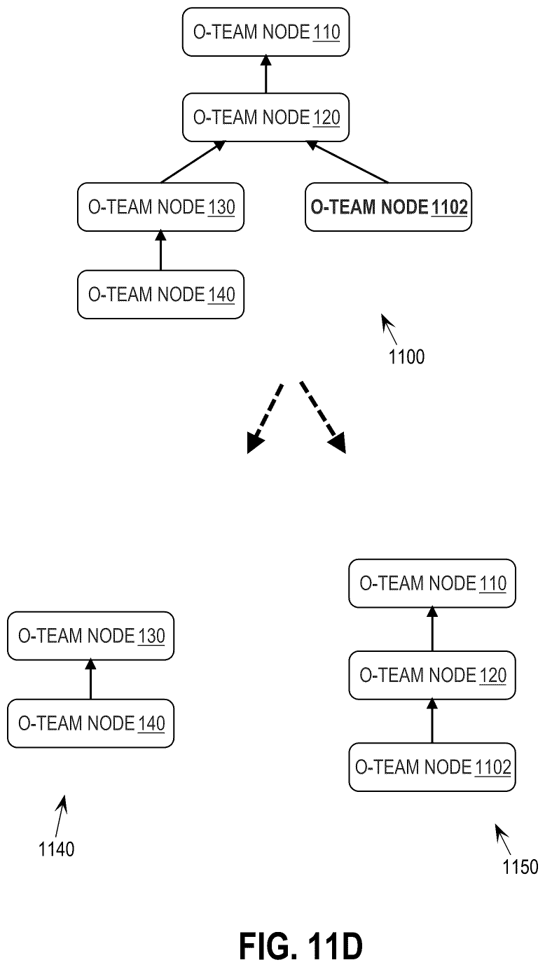

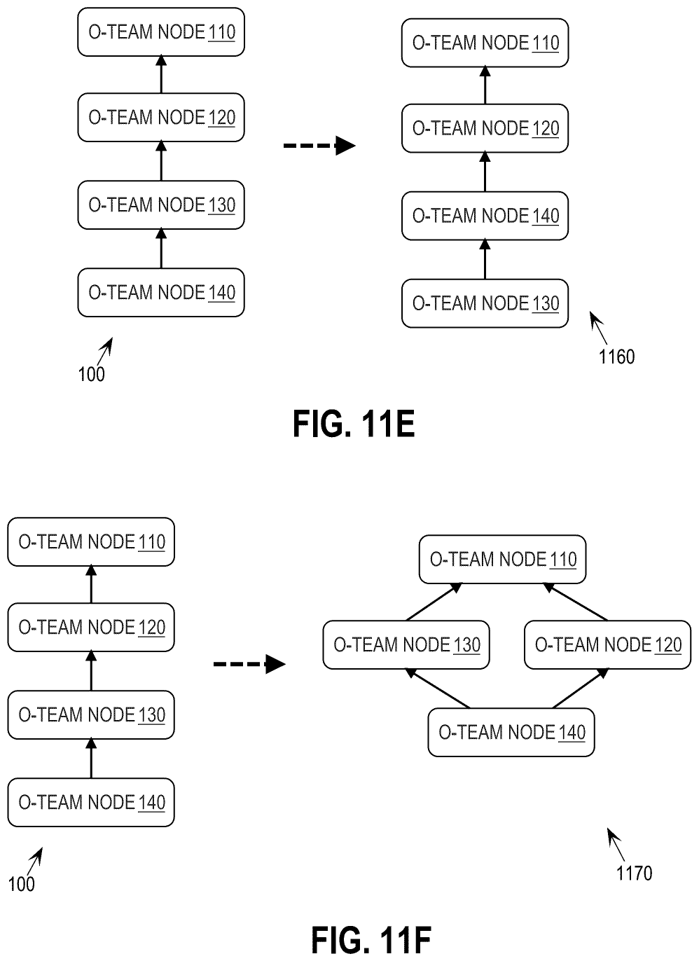

For example, FIG. 11A depicts example team node tree 100 being changed to add a new team node 1102, which produces an adjusted team node tree 1100. As indicated above, access metadata 102 associated with team node 110, which continues to be the root node of adjusted team node tree 1100, includes child resource access rules that indicate that (a) members of each team node in the hierarchy have the default right to inspect the resources associated with all descendant team nodes that are reachable from the team node, and (b) members of each team node in the hierarchy have the default right to read the resources associated with child team nodes that are at most one hop away from the team node. Thus, adding new node 1102 results in effective access policies of team nodes 110 and 120 (which are parent nodes of new node 1102) automatically being adjusted to include new boundary access statements that grant the right to inspect the resources associated with new team node 1102. Furthermore, adding new node 1102 results in the effective access policy of team node 120 automatically being adjusted to include a new boundary access statement that grants the right to read the resources associated with new team node 1102, given that team node 120 is the direct parent of new team node 1102.

8.2. Removing a Node from a Team Node Tree

Another change to hierarchical relationships within a team node tree that can result in changed effective access policies is removing a team node from a team node tree. According to various implementations, removing a team node from a team node tree requires adjusting the effective access policies for all parent nodes that were reachable from the removed team node to remove any boundary access policy statements defining access rights for the resources of the removed node.

For example, FIG. 11B depicts example team node tree 100 being changed to remove team node 130, which produces an adjusted team node tree 1110. Because node 130 is removed from the tree, the effective access policies maintained for team nodes 120 and 110 are automatically adjusted to remove the boundary access policy statements that defined access rights for parent team members regarding the resources for team node 130.

8.3. Moving all, or a Portion of, One Team Node Tree into Another Team Node Tree

Another change to hierarchical relationships within a team node tree that can result in changed effective access policies is moving all or a portion of one team node tree to be part of another team node tree, i.e., in a forest maintained for a target organization. According to various implementations, adding a portion of one team node tree to another team node tree requires (a) adjusting the effective access policies for all parent nodes, reachable from the moved team node(s), to include boundary access statements defining parent access rights for the resources of the moved team node(s), and (b) adjusting boundary access policies for the moved team node(s) to remove boundary access statements for team nodes that no longer have relationships with the moved team nodes, to add boundary access statements based on any new relationships relating descendant team nodes and the moved team nodes within the team node tree, and potentially (i) automatically adjusting the effective access policies of the moved team nodes to conform to the newly applicable access metadata and/or (ii) flagging access statements for the moved team nodes that may need to be adjusted by an administrator user such as access statements that were automatically generated with default rights based on previously-applicable access metadata.

To illustrate, FIG. 11C depicts example team node tree 100 being added as a subtree of another team node tree 1120 to form an adjusted team node tree 1130. In this example, access metadata 1132 for team node tree 1130 has different child resource access rules and different default access rules than access metadata 102 applicable to team node tree 100. According to various implementations, because the root node 110 of team node tree 100 has become a child node of root node 1122 of team node tree 1120, access metadata 1132 is used to adjust any default privileges in the effective access policies for team nodes 110-140. Based on configuration information for the OBAC system, any access statement for team nodes 110-140 that is based on the default access rules in access metadata 102, and that has not been adjusted by an administrator, are automatically recalculated based on access metadata 1132.

Furthermore, team nodes 1122 and 1124 are now parent nodes of team nodes 110-140. Thus, the effective access policies for nodes 1122 and 1124 are recalculated to add boundary policies to govern access rights for members of team nodes 1122 and 1124 regarding the resources of new nodes 110-140, as described above in connection with addition of a new node into a team node tree above.

8.4. Dividing a Team Node Tree into Multiple Team Node Trees

Yet another change to hierarchical relationships within a team node tree that can result in changed effective access policies is dividing a team node tree into multiple team node trees. In this case, the effective access policies of the team nodes in the resulting team node trees are adjusted to account for the removal of team nodes. Also, the resulting team node tree that has a different root node is adjusted to associate access metadata with the team node tree, where the access metadata may be the same access metadata as the previously-applicable access metadata or may be initial access metadata defined in configuration information for the OBAC system.

To illustrate, FIG. 11D depicts example team node tree 1100 being split into adjusted team node trees 1140 and 1150. In this example, team node 130 is the new root node of tree 1140. According to various implementations, the same access metadata as access metadata 102 (associated with node 110) is associated with new root node 130. However, since the child nodes of node 130 and node 140 did not change, then no recalculation of the effective access policies of these nodes is performed.

For adjusted team node tree 1150, which retains root node 110, the effect of the change is that the hierarchy loses nodes 130 and 140. Accordingly, while the effective access policy of leaf team node 1102 is not recalculated, the effective access policies of team nodes 110 and 120 are automatically adjusted to account for the removal of team nodes 130 and 140, as described above.

8.5. Changing the Positions of Nodes of a Team Node Tree

Another change to hierarchical relationships within a team node tree that can result in changed effective access policies is changing the positions between nodes of a team node tree such that one or more nodes in the tree have adjusted parent-child relationships. In effect, changed relationships can cause some team nodes to lose descendant nodes and cause some team nodes to gain descendant nodes, and the effective access policies are adjusted as described above.

To illustrate, FIG. 11E depicts the relationships of example team node tree 100 being changed to switch the positions of team node 130 and team node 140 to produce adjusted team node tree 1160. In this case, in team node tree 100, team node 140 was a leaf node, and team node 130 was the direct parent of team node 140 and the direct child of team node 120. In adjusted team node tree 1160, team node 130 is a leaf node, and team node 140 is the direct parent of team node 130 and the direct child of team node 120. In this case, the effective access policies of nodes 110 and 120 need not be adjusted since both nodes 130 and 140 are still reachable from both of nodes 110 and 120. Furthermore, according to OBAC system configuration, the effective access policies of the team nodes may be adjusted based on the adjusted numbers of hops between the nodes, which may affect application of the default access rules in access metadata 102. Also, since team node 140 is no longer a child node of team node 130, the effective access policy of team node 130 is automatically adjusted to remove the boundary access policies that defined access rights for the resources associated with node 140. Furthermore, the effective access policy of node 140 is also adjusted based on the addition of team node 130 as a child node of team node 140, as described above.

As yet another example, FIG. 11F depicts the relationships of example team node tree 100 being changed to move team node 130 from being the direct child of team node 120 to being the direct child of team node 110 to produce an adjusted team node tree 1170. Also, team node 140 is adjusted to be a direct child of team node 120 in addition to being the direct child of team node 130 within adjusted team node tree 1170. In this case, the effective access policy for team node 120 is adjusted to remove the boundary access statement defining access rights for resources of team node 130, since team node 130 is no longer a child node of team node 120. Furthermore, according to OBAC system configuration, the effective access policies of team node 110 and team node 130 are adjusted based on the adjusted numbers of hops between the nodes, which may affect application of the default access rules in access metadata 102. It is noted that addition of any nodes under node 140 within adjusted team node tree 1170 would require recalculation of access policies for both team node 120 and team node 130, which are now both parents of team node 140, as well as for team node 110, which is the root node of the hierarchy.

### 9. Hardware Overview

An application, such as access policy metadata application 806, runs on a computing device and comprises a combination of software and allocation of resources from the computing device. Specifically, an application is a combination of integrated software components and an allocation of computational resources, such as memory, and/or processes on the computing device for executing the integrated software components on a processor, the combination of the software and computational resources being dedicated to performing the stated functions of the application.

One or more of the functions attributed to any process described herein, may be performed any other logical entity that may or may not be depicted in FIG. 8, according to one or more implementations. In some implementations, each of the techniques and/or functionality described herein is performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

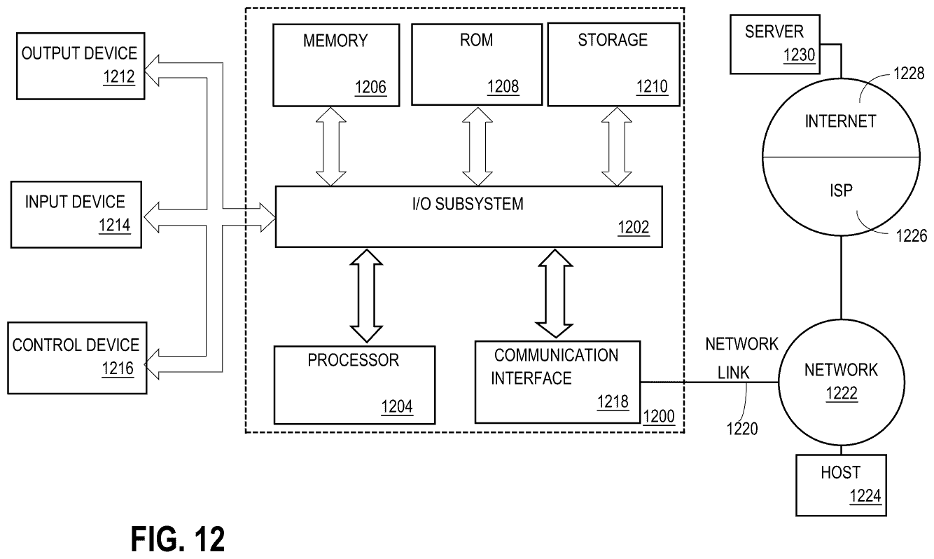

For example, FIG. 12 is a block diagram that illustrates a computer system 1200 upon which an embodiment of the invention may be implemented. Computer system 1200 includes a bus 1202 or other communication mechanism for communicating information, and a hardware processor 1204 coupled with bus 1202 for processing information. Hardware processor 1204 may be, for example, a general purpose microprocessor.

Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage median accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk, optical disk, or solid-state drive is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative implementations, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1210. Volatile media includes dynamic memory, such as main memory 1206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

### 10. Software Overview

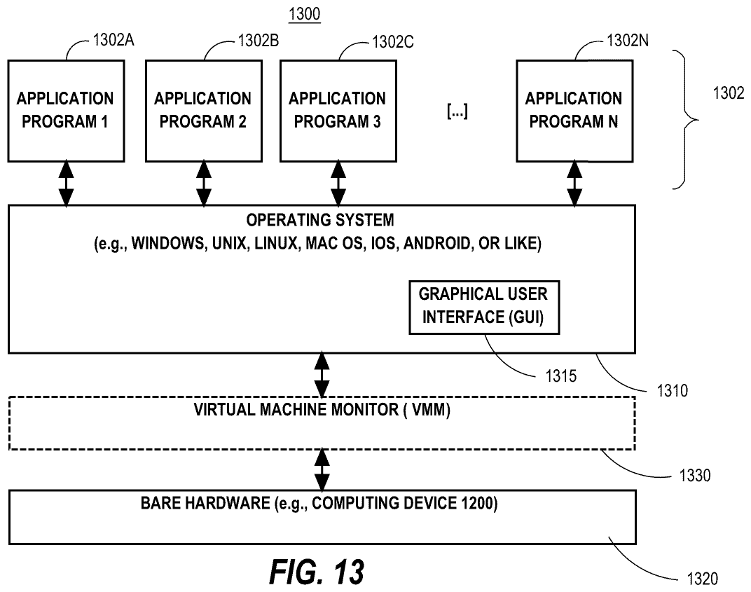

FIG. 13 is a block diagram of a basic software system 1300 that may be employed for controlling the operation of computer system 1200. Software system 1300 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1300 is provided for directing the operation of computer system 1200. Software system 1300, which may be stored in system memory (RAM) 1206 and on fixed storage (e.g., hard disk or flash memory) 1210, includes a kernel or operating system (OS) 1310.

The OS 1310 manages low-level aspects of computer operation, including managing execution of processes, memory allocation, file input and output (I/O), and device I/O. One or more application programs, represented as 1302A, 1302B, 1302C . . . 1302N, may be “loaded” (e.g., transferred from fixed storage 1210 into memory 1206) for execution by the system 1300. The applications or other software intended for use on computer system 1200 may also be stored as a set of downloadable computer-executable instructions, for example, for downloading and installation from an Internet location (e.g., a Web server, an app store, or other online service).

Software system 1300 includes a graphical user interface (GUI) 1315, for receiving user commands and data in a graphical (e.g., “point-and-click” or “touch gesture”) fashion. These inputs, in turn, may be acted upon by the system 1300 in accordance with instructions from operating system 1310 and/or application(s) 1302. The GUI 1315 also serves to display the results of operation from the OS 1310 and application(s) 1302, whereupon the user may supply additional inputs or terminate the session (e.g., log off).

OS 1310 can execute directly on the bare hardware 1320 (e.g., processor(s) 1204) of computer system 1200. Alternatively, a hypervisor or virtual machine monitor (VMM) 1330 may be interposed between the bare hardware 1320 and the OS 1310. In this configuration, VMM 1330 acts as a software “cushion” or virtualization layer between the OS 1310 and the bare hardware 1320 of the computer system 1200.

VMM 1330 instantiates and runs one or more virtual machine instances (“guest machines”). Each guest machine comprises a “guest” operating system, such as OS 1310, and one or more applications, such as application(s) 1302, designed to execute on the guest operating system. The VMM 1330 presents the guest operating systems with a virtual operating platform and manages the execution of the guest operating systems.

In some instances, the VMM 1330 may allow a guest operating system to run as if it is running on the bare hardware 1320 of computer system 1200 directly. In these instances, the same version of the guest operating system configured to execute on the bare hardware 1320 directly may also execute on VMM 1330 without modification or reconfiguration. In other words, VMM 1330 may provide full hardware and CPU virtualization to a guest operating system in some instances.

In other instances, a guest operating system may be specially designed or configured to execute on VMM 1330 for efficiency. In these instances, the guest operating system is “aware” that it executes on a virtual machine monitor. In other words, VMM 1330 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### 11. Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, implementations of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-executed method for filesystem access control, comprising:
maintaining graph data comprising a team node tree that comprises a plurality of team nodes and one or more hierarchical relationships between the plurality of team nodes, each team node of the plurality of team nodes being associated with:
(a) one or more users in a represented team,
(b) a set of resources for the represented team,
(c) a team node-specific set of policies that define rights of the one or more users to access the set of resources for the represented team, and
(d) one or more other team nodes as either a parent node or child node of each of the one or more other team nodes;
for each team node of a set of parent team nodes in the team node tree, determining an effective access policy, for said each team node, comprising:
the team node-specific set of policies for said each team node, and
one or more boundary access policies that define rights for the one or more users of said each team node to access a set of child resources comprising one or more sets of resources associated with child nodes of said each team node;
detecting an instruction, from a particular user that is associated with a particular team node of the team node tree, to perform an access operation, of a particular type, on a particular resource that is associated with a particular child team node of the particular team node;
responsive to detecting the instruction:
determining that the particular user has the right to perform the particular type of access operation on the particular resource based, at least in part, on information from the effective access policy for the particular team node, and
responsive to determining that the particular user has the right to perform the particular type of access operation on the particular resource, causing performance of the access operation instructed by the instruction;
wherein the method is performed by one or more computing devices.

2. The computer-executed method of claim 1, wherein the one or more boundary access policies for a particular parent team node of the set of parent team nodes allow access to resources from multiple child team nodes of the particular parent team node.

3. The computer-executed method of claim 1, wherein:
the team node tree is associated with a set of one or more child resource access rules; and
the method further comprises, for each team node in the team node tree that is associated with one or more child nodes: based, at least in part, on the set of one or more child resource access rules, determining one or more default boundary access policies for said each team node.

4. The computer-executed method of claim 1, further comprising:
detecting a second instruction, from a second user associated with the particular child team node, to perform a second access operation, of the particular type, on the particular resource;
responsive to detecting the second instruction:
determining that the second user does not have the right to perform the particular type of access operation on the particular resource based on information from a team node-specific access policy associated with the particular child team node, and
responsive to determining that the second user does not have the right to perform the particular type of access operation on the particular resource, denying performance of the second access operation instructed by the second instruction.

5. The computer-executed method of claim 4, wherein determining that the second user does not have the right to perform the particular type of access operation on the particular resource is based on an explicit denial of the particular type of access operation for the particular resource in the team node-specific access policy associated with the particular child team node.

6. The computer-executed method of claim 1, further comprising:
detecting a change within the graph data for the team node tree comprising one or more of:
deletion of a team node from the team node tree,
addition of a team node to the team node tree,
changing one or more relationships between two or more team nodes of the team node tree,
merging one or more other team node trees with the team node tree,
splitting the team node tree into multiple team node trees, or
changing information for a root node of the team node tree;
responsive to detecting the change within the graph data for the team node tree:
performing one or more adjustment actions for one or more boundary access policies for one or more parent team nodes of the team node tree to produce one or more adjusted boundary access policies, and
determining one or more adjusted effective access policies for respective one or more team nodes of the team node tree based, at least in part, on the one or more adjusted boundary access policies.

7. The computer-executed method of claim 1, wherein:
the particular user is associated with multiple team nodes within the graph data; and
the method further comprises:
storing, for the particular user, particular effective access policy information that comprises information from the effective access policy determined for each team node of the multiple team nodes;
wherein said determining that the particular user has the right to perform the particular type of access operation on the particular resource is performed based on the stored particular effective access policy information.

8. The computer-executed method of claim 1, wherein the information from the effective access policy for the particular team node is based on a boundary access policy that uniquely identifies the particular resource.

9. The computer-executed method of claim 8, wherein the boundary access policy grants an access privilege for a second resource, associated with the particular child team node, based on uniquely identifying the second resource within the boundary access policy.

10. The computer-executed method of claim 1, wherein the information from the effective access policy for the particular team node is based on a boundary access policy that identifies the particular resource based on an identifier of the particular resource matching a regular expression in the boundary access policy.

11. The computer-executed method of claim 1, wherein the information from the effective access policy for the particular team node is based on a boundary access policy that identifies the particular resource based on an identifier of a group of resources that includes the particular resource.

12. The computer-executed method of claim 1, wherein:
the particular resource is an attribute of a data entity; and
the information from the effective access policy for the particular team node is based on a boundary access policy that identifies the attribute and defines one or more privileges for the attribute.

13. The computer-executed method of claim 1, wherein the effective access policy for the particular team node identifies resources at two or more of: a multi-segment level of granularity, a segment level of granularity, an extent level of granularity, a data block level of granularity, a multi-file level of granularity, a file-level of granularity, a data object level of granularity, or a sub-data object level of granularity.

14. A computer-executed method for filesystem access control, comprising:
maintaining graph data comprising a team node tree that comprises a plurality of team nodes and one or more hierarchical relationships between the plurality of team nodes, each team node of the plurality of team nodes being associated with:
(a) one or more users in a represented team,
(b) a set of resources for the represented team,
(c) a team node-specific set of policies that define rights of the one or more users to access the set of resources for the represented team, and
(d) one or more other team nodes as either a parent node or child node of each of the one or more other team nodes;
wherein a particular team node, of the plurality of team nodes, is associated with a management access policy that define rights of the one or more users associated with the particular team node to manage graph data for a subset of the team node tree comprising one or both of: the particular team node, or one or more child nodes of the particular team node;
detecting an instruction, from a particular user that is associated with the particular team node, to perform a particular management operation on graph data for a team node in the subset of the team node tree;
responsive to detecting the instruction:
determining that the particular user has the right to perform the particular management operation based, at least in part, on information from the management access policy associated with the particular team node, and
responsive to determining that the particular user has the right to perform the particular management operation, causing performance of the particular management operation.

15. One or more non-transitory computer-readable media storing instructions that, when executed by one or more processors, cause:
maintaining graph data comprising a team node tree that comprises a plurality of team nodes and one or more hierarchical relationships between the plurality of team nodes, each team node of the plurality of team nodes being associated with:
(a) one or more users in a represented team,
(b) a set of resources for the represented team,
(c) a team node-specific set of policies that define rights of the one or more users to access the set of resources for the represented team, and
(d) one or more other team nodes as either a parent node or child node of each of the one or more other team nodes;
for each team node of a set of parent team nodes in the team node tree, determining an effective access policy, for said each team node, comprising:
the team node-specific set of policies for said each team node, and
one or more boundary access policies that define rights for the one or more users of said each team node to access a set of child resources comprising one or more sets of resources associated with child nodes of said each team node;
detecting an instruction, from a particular user that is associated with a particular team node of the team node tree, to perform an access operation, of a particular type, on a particular resource that is associated with a particular child team node of the particular team node;
responsive to detecting the instruction:
determining that the particular user has the right to perform the particular type of access operation on the particular resource based, at least in part, on information from the effective access policy for the particular team node, and
responsive to determining that the particular user has the right to perform the particular type of access operation on the particular resource, causing performance of the access operation instructed by the instruction.

16. The one or more non-transitory computer-readable media of claim 15, wherein the one or more boundary access policies for a particular parent team node of the set of parent team nodes allow access to resources from multiple child team nodes of the particular parent team node.

17. The one or more non-transitory computer-readable media of claim 15, wherein:
the team node tree is associated with a set of one or more child resource access rules; and
the instructions further comprise instructions that, when executed by one or more processors, cause, for each team node in the team node tree that is associated with one or more child nodes: based, at least in part, on the set of one or more child resource access rules, determining one or more default boundary access policies for said each team node.

18. The one or more non-transitory computer-readable media of claim 15, wherein the instructions further comprise instructions that, when executed by one or more processors, cause:
detecting a second instruction, from a second user associated with the particular child team node, to perform a second access operation, of the particular type, on the particular resource;
responsive to detecting the second instruction:
determining that the second user does not have the right to perform the particular type of access operation on the particular resource based on information from a team node-specific access policy associated with the particular child team node, and
responsive to determining that the second user does not have the right to perform the particular type of access operation on the particular resource, denying performance of the second access operation instructed by the second instruction.

19. The one or more non-transitory computer-readable media of claim 18, wherein determining that the second user does not have the right to perform the particular type of access operation on the particular resource is based on an explicit denial of the particular type of access operation for the particular resource in the team node-specific access policy associated with the particular child team node.

20. The one or more non-transitory computer-readable media of claim 15, wherein the instructions further comprise instructions that, when executed by one or more processors, cause:
detecting a change within the graph data for the team node tree comprising one or more of:
deletion of a team node from the team node tree,
addition of a team node to the team node tree,
changing one or more relationships between two or more team nodes of the team node tree,
merging one or more other team node trees with the team node tree,
splitting the team node tree into multiple team node trees, or
changing information for a root node of the team node tree;
responsive to detecting the change within the graph data for the team node tree:
performing one or more adjustment actions for one or more boundary access policies for one or more parent team nodes of the team node tree to produce one or more adjusted boundary access policies, and
determining one or more adjusted effective access policies for respective one or more team nodes of the team node tree based, at least in part, on the one or more adjusted boundary access policies.
